(19) United States
(12) Patent Application Publication
(10) Pub. No.: US 2025/0277406 A1
(43) Pub. Date: Sep. 4, 2025

(54) FLOATING RAIL SYSTEM AND TRACKS FOR MOUNTING RETRACTABLE SCREENS

(71) Applicant: Alutech United, Inc., Selbyville, DE (US)

(72) Inventor: Aaron Woods, Selbyville, DE (US)

(21) Appl. No.: 19/068,216

(22) Filed: Mar. 3, 2025

Related U.S. Application Data
(60) Provisional application No. 63/560,316, filed on Mar. 1, 2024.

(51) Int. Cl. E06B 9/58; E06B 9/54

(52) U.S. Cl. CPC E06B 9/58; E06B 9/54; E06B 2009/543; E06B 2009/587

(57) ABSTRACT

A retractable screen system includes a screen that is movable, via rotational movement of a motor to raise and lower the screen in a vertical manner. The screen can start at the motor and retract downward. To aid in the controlled movement of the screen, a track system includes an outer rail housing an inner channel. The inner channel includes a channel for receiving a portion of the screen, such as a keder. The keder channel controls the movement of the keder and screen. At times, the outer rail or inner channel may not be oriented as desired, and therefore, the inner channel includes the ability to float or move in a direction transversely to the direction of movement of the screen. Plastic clips can urge the inner channel to a position but can be manipulated to allow for some float of the inner channel.

### CROSS REFERENCE TO RELATED APPLICATIONS

This application claims priority under 35 U.S.C. § 119(e) to provisional patent application U.S. Ser. No. 63/560,316, filed Mar. 1, 2024. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to retractable screens. More particularly, but not exclusively, the disclosure includes aspects and/or embodiments of motorized retractable screens, including tracks and keder systems that move in the tracks to move a screen relative to the tracks.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Motorized retractable screens have many applications and provide numerous benefits. The screens provide flexibility to homeowners, business owners, and generally anyone with an outdoor structure that would like the ability to change between fully outside and partial enclosed spaces. Decks, patios, doors, windows, garages, lanais, balconies, store fronts, kiosks, and generally any wide opening can be fitted with the motorized screens to allow for selective enclosure of the areas.

In addition, the retractable screens can provide numerous benefits. These can include hurricane or other weather safety, privacy, security, insect protection, shading, energy savings, and more. As these can be screens, the fabric material may not fully block out views as well, allowing people to have both the benefit of enjoying an outdoor environment while also having one or more of the benefits. The movement or motorization can be manual or electronic, such as via a remote device, which can be a remote control device, switch, an application on an electric device (e.g., phone, tablet, smart device, etc.) or generally any device that is communicable via a wired or wireless communication network to activate a motor for moving the retractable screen.

Generally, the motorized screen includes a track system, including a driven member moving within a track along one or more sides of a frame of the area to be enclosed with the screen. The driven member or members is connected to the fabric of the screen and moved through the track to raise and lower the screen. The tracks are used to maintain the screen in a tight or taut manner. For example, the tracks are generally vertically mounted and on opposite sides of an opening to be enclosed with the screen. The tracks may be attached to a portion of a structure.

However, the tracks are not always vertical, both in mounting and during use thereof. The structures may not be ideally vertical during construction or due to settling or other earth movements. Weather, such as wind, may also affect the placement of the tracks and screen. In addition, the mounting of the tracks may not always be placed as ideally as possible, meaning that opposing tracks (i.e., tracks on opposite sides of an opening) may not be as parallel as needed to allow the driven members to move to open and close.

Thus, there exists a need in the art for an apparatus and/or system that improves on retractable screens to allow for some play, as well as making up for issues of the tracks, including having the tracks mounting in non-parallel configurations, which may be outside of acceptable tolerances for the screen mounts.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of any of the aspects and/or embodiments of the present disclosure to improve upon installation of retractable screens. For example, the screens move along track systems, and these track systems are not always perfectly aligned. Aspects include a floating member to account for misaligned or oriented mounts. The system also allows for the installation of track systems in locations where the structure is not as aligned as desired.

It is still yet a further object, feature, and/or advantage of any of the aspects and/or embodiments of the present disclosure to improve upon the installation and operation of retractable screen systems that have high durability and quality.

The systems disclosed herein can be used in a wide variety of applications. For example, retractable screens can be used for a number of reasons and in a number of locations, and the specific type of screen is not to be limiting on the disclosure. For example, the retractable screens can provide shade, provide safety from storms, including hurricanes, provide security, provide privacy, provide protection from other weather, provide energy savings, provide protection from insects and other elements, and/or provide some combination of these features.

In addition, the location related to a structure is not to be limiting. For example, the retractable screen systems could be used with wide openings, garage doors, lanais/balconies, sunrooms/skylights, French doors, store fronts/kiosks, or other openings.

It is preferred the apparatus be safe, cost effective, and durable. For example, the system can be adapted to resist excessive heat, static buildup, corrosion, and/or mechanical failures (e.g., cracking, crumbling, shearing, creeping) due to excessive impacts and/or prolonged exposure to tensile and/or compressive forces acting on the system. As noted, due to the wide range of uses, it is preferable that aspects of the system be able to withstand high winds, forces, sunlight, insects and animals, and the like.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the system, including any aspects thereof.

Methods can be practiced which facilitate use, manufacture, assembly, maintenance, and repair of a system which accomplish some or all of the previously stated objectives.

According to some aspects of the present disclosure, a retractable screen system comprises a screen comprising a height and a width, said width defined by opposite lateral ends; a plurality of guide members spaced vertically along the opposite lateral ends of the screen; a track system at both of the lateral ends of the screen, each track system comprising: an outer rail; a screen connector including an inner channel movably positioned within a portion of outer rail; and one or more tension springs positioned adjacent the screen connector in the outer rail; wherein the plurality of guide members movable through the inner channel; and wherein the screen connector movable in a direction transverse to the movement of the guide members.

According to at least some aspects of some embodiments of the present disclosure, the one or more tension springs urge the screen connector away from a center of the screen.

According to at least some aspects of some embodiments of the present disclosure, the outer rail comprises an outer connection portion for connecting to a mounting member, and an inner track, wherein the screen connector and one or more tension springs positioned in the inner track.

According to at least some aspects of some embodiments of the present disclosure, the one or more tension springs are connected to the screen connector.

According to at least some aspects of some embodiments of the present disclosure, the screen comprises fabric.

According to at least some aspects of some embodiments of the present disclosure, the plurality of guide members are connected to the screen via welding tape.

According to at least some aspects of some embodiments of the present disclosure, the system further comprises a wall mount.

According to at least some aspects of some embodiments of the present disclosure, the track system connects to the wall mount.

According to at least some aspects of some embodiments of the present disclosure, the plurality of guide members comprise keders.

According to at least some aspects of some embodiments of the present disclosure, the system further comprises a rolling motor operatively connected to the screen to raise and lower the screen.

According to additional aspects of the disclosure, a track system for use with a retractable screen having a guide member attached to opposite lateral ends of the screen comprises an outer rail; a screen connector including an inner channel movably positioned within a portion of outer rail; and one or more tension springs positioned adjacent the screen connector in the outer rail; wherein the plurality of guide members movable through the inner channel.

According to at least some aspects of some embodiments of the present disclosure, the outer rail comprises an outer connection portion for connecting to a mounting member, and an inner track, wherein the screen connector and one or more tension springs positioned in the inner track.

According to at least some aspects of some embodiments of the present disclosure, the one or more tension springs are connected to the screen connector.

According to at least some aspects of some embodiments of the present disclosure, the system further comprises a wall mount.

According to at least some aspects of some embodiments of the present disclosure, the outer rail connects to the wall mount.

According to at least some aspects of some embodiments of the present disclosure, the plurality of guide members comprise keders.

According to additional aspects of the disclosure, a floating rail system for use with retractable screens comprises an outer rail comprising a first portion for attaching to a wall mount and a second section comprising a channel; a floating screen connector positioned in the channel of the outer rail, the floating screen connector comprising an inner channel and a tension spring; wherein the tension spring urges the inner channel in the channel of the outer rail and allows the inner channel to move in the channel.

According to at least some aspects of some embodiments of the present disclosure, the channel of the outer rail comprises a C-shape with an open end.

According to at least some aspects of some embodiments of the present disclosure, the inner channel comprises a guide channel for receiving a guide member of a screen.

According to at least some aspects of some embodiments of the present disclosure, the guide channel is substantially circular in shape.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is an example view of a retractable screen system including a roller top and a screen with a bottom bar extending between opposing track systems.

FIG. 2 is a side sectional view of FIG. 1.

FIG. 3 is a top sectional view of FIG. 1.

FIG. 4 is a perspective, sectional view of a track system for use with a retractable screen according to at least some aspects of some embodiments of the present disclosure.

FIG. 5 is another perspective, sectional view of a portion of a track system showing the bottom section thereof.

FIG. 6 is a view similar to FIG. 5, but from a different orientation.

FIG. 7 is another perspective, sectional view of a portion of a track system showing the bottom section thereof.

FIG. 8 is a view similar to FIG. 7, but from a different orientation.

FIG. 9 is a view similar to FIG. 7, but with a portion of the inner rail moved.

FIG. 10 is another perspective, sectional view of a track system for use with a retractable screen according to at least some aspects of some embodiments of the present disclosure.

FIG. 11 is a sectional view similar to FIG. 10.

FIG. 12 is another sectional view similar to FIG. 10.

FIG. 13 is another perspective, sectional view of a track system for use with a retractable screen according to at least some aspects of some embodiments of the present disclosure.

FIG. 14 is another perspective, sectional view of a track system for use with a retractable screen according to at least some aspects of some embodiments of the present disclosure.

FIG. 15 is a top view of an outer rail according to aspects of the disclosure.

FIG. 16 is a view similar to FIG. 15 showing the visible portions thereof.

FIG. 17 is an enlarged portion of FIG. 15.

FIG. 18 is another enlarged portion of FIG. 15.

FIG. 19 is an end view of an inner rail according to aspects of the disclosure.

FIG. 20 is a view similar to FIG. 19 showing the visible portions thereof.

FIG. 21 is an enlarged portion of FIG. 19.

FIG. 22 is a perspective view of keders attached to a portion of a screen.

FIG. 23 is a front view of FIG. 22.

FIG. 24 is a top view of FIG. 22.

FIG. 25 is an end view of FIG. 22 looked at the keders.

FIGS. 26A-26C are views of various configurations of rollers for use with aspects and/or embodiments of the disclosure.

FIGS. 27A-27E are views showing aspects including various views of guide members both in and out of channels of the disclosure.

FIG. 28 is a view showing aspects of the track system and guide member with blind from a top perspective.

FIG. 29 is a front elevation view showing various components of a retractable screen system according to aspects of the disclosure, including cutaways of at least some of the components to show relationships between said components.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Roll shutters, also referred to as retractable screens, provide a number of benefits. The screens can be used at any opening of any structure and can provide hurricane and storm protection, insect protection, security, shading and sun control, or otherwise just provide a movable opening and closing for an opening. Roll activated screens include the use of a roller member that is operably attached to a screen. As will be understood from the present disclosure, guide members in the form of keders can be used to attach to a screen, fabric, shutter, or the like (collectively, a screen). One or more of the keders can also be connected to a roller, wherein the rolling of the roller will move the guide members vertically in order to thus move the screen vertically. This can be in either direction (i.e., up or down). The rollers can be operated in a number of manners. For example, motorization of the rollers can be controlled via automation control (e.g., including, but not limited to remote controls, smart phones, cell phones, handhelds, tablets, smart devices, push switches, or the like), or the screen can be manipulated via manual controls (cranks or cords). For automated operation, an electric motor can be included with the roller and operated from a wired or wireless connection, such as via one or more of the automation controls provided.

It should be understood that the aspects and/or embodiments of the present disclosure are not to be limited to any one type of control or operation of the rollers, and thus, the means of movement for the screen, and that any of the types of movement are contemplated as part of the disclosure.

Still further, as mentioned, herein, while the roller/motor will be positioned in a housing at an upper portion of the opening, there will be tracks along the sides of the opening to aid in the movement of the screen. The structures and/or mounting portions of the retractable screens may not always be as desired. For example, it would work best for the width of the opening to be consistent along the height of the opening, and the mounting matching the width along the height. It would also be desired if the height of the opening of the structure be consistent. This is not always the case.

As will be understood, aspects of embodiments of the present disclosure provide for solutions to the problem where a structure is not ideally sized and oriented (e.g., the sides and tops/bottoms not 90° from one another and also not consistent in height or width) and/or the situation where mounting structures for a retractable screen system, such as that disclosed herein, is not properly mounted such that there are variations to the height and/or width of the opening. As will be understood, the present disclosure will provide some additional tolerances to account for at least some variations to the width and/or height to allow the retractable screens to continue to operate as desired, even with such deficiencies or misfeatures.

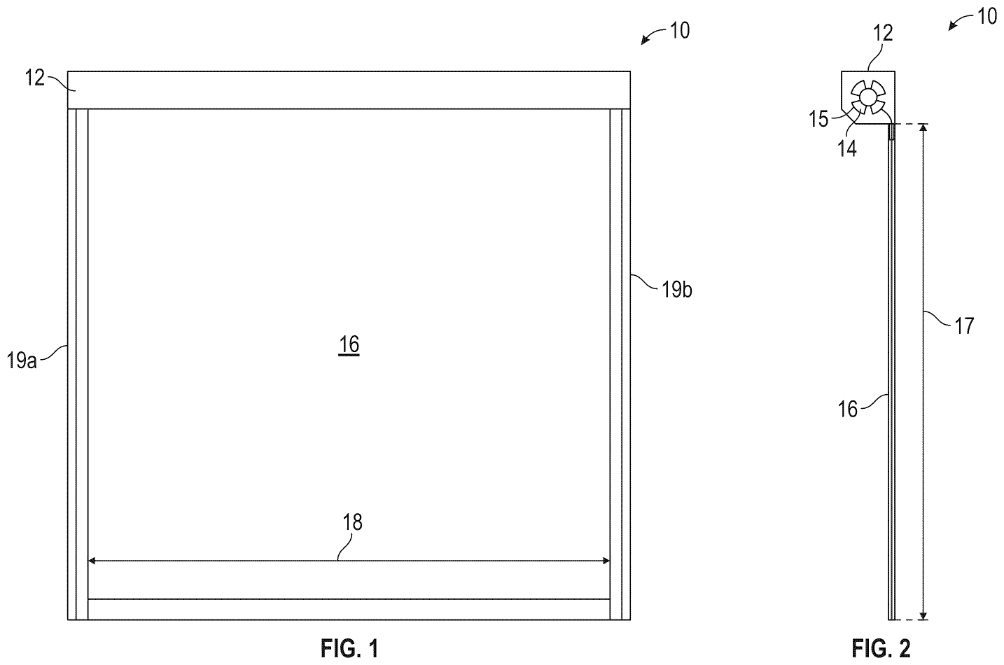

Therefore, an example of a retractable screen system 10 is shown in FIGS. 1 and 2. FIG. 1 shows the screen system from a front view, such as would be viewed in a fully closed position in which the opening of the structure is closed via the screen system 10. As shown in the figure, the system 10 includes a housing 12 that houses the roller 14 and motor 15, when a motorized version is used. A screen 16 is shown. The screen includes a height 17 (see, e.g., FIG. 2) that is at least as much as the opening to be blocked with the screen 16. In addition, the screen 16 has a width 18 extending between lateral sides 19a and 19b. The lateral sides 19a and 19b may refer to the opposing walls of the structure, or to mounting features, such as part of rail mount system, as will be included herein.

The width 18 of the screen 16 is set by the width of the opening between the opposing, lateral sides 19a and 19b. As noted, this is not always consistent and may include variations in dimensions along the height of the opening.

The screen 16, also referred to as fabric, shutters, extruded aluminum, vinyl, foam filled aluminum, or some combination thereof. According to at least some aspects, when the screen is a hurricane/storm screen, the material can comprise a fabric 0.027″ diameter vinyl coated 1500 denier polyester core yarns in warp and 0.030″ diameter vinyl coated 2000 denier Twaron core yarns in fill.

To aid in mounting the retractable screen system 10, a track system 30 can be used. The track system 30 may also be referred to as a floating rail mount system, and the terms can be used interchangeably herein.

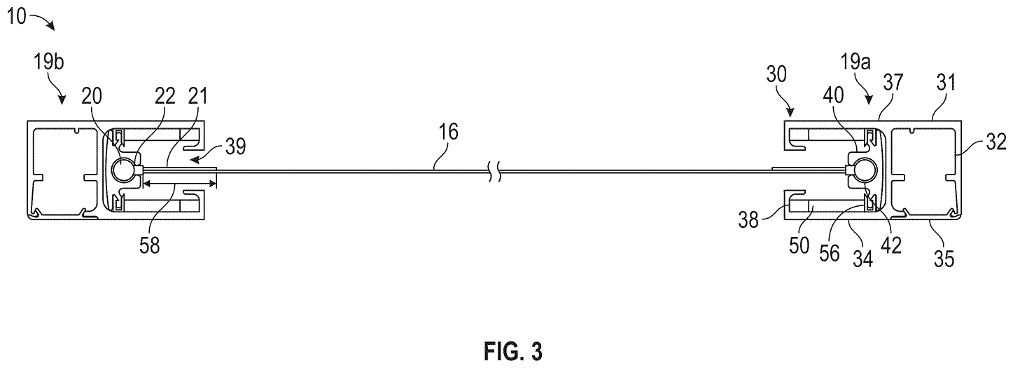

FIG. 3 is a top down sectional view of a retractable screen system 10, such as that shown in FIG. 1. FIG. 3 shows more details on the mounting structures, rail structures, and movement components of the screen system 10. For example, as noted above, the screen 16 has a width 18 that spans between opposing lateral sides 19a and 19b. These sides (19a and 19b) could refer to opposing lateral structural components or to opposing lateral components of a track system 30, such as is shown in FIG. 3. The track system 30 includes opposing outer rails 31 that define the outer width locations of the screen 16. As will be understood, the outer rails 31 of the track system 30 provide mounting, support, and other benefits for mounting and encouraging movement of a retractable screen 16 of a system 10. The outer rails 31 can connect to or otherwise house many components of such a retractable screen system 10 and can even include “floating” components that are movable generally transversely compared to the height of the screen 16 to allow for handling of non-parallel outer rails or structural elements that the outer rails 31 are mounted.

As will be understood, both of the track systems 30 (i.e., each track system on opposing lateral positions connected to the screen) are generally similar to one another and mirrored to one another. Therefore, it should be noted that the description of one of the track systems 30 (e.g., the left track system shown in FIG. 3) will equally apply to the other.

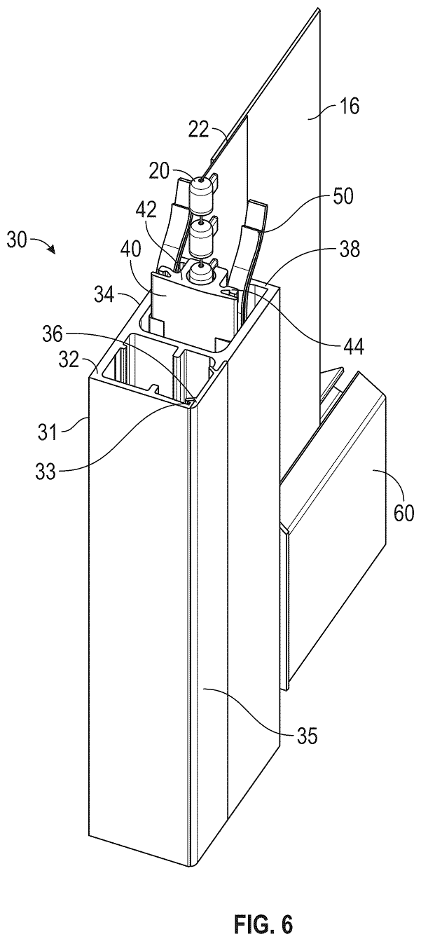

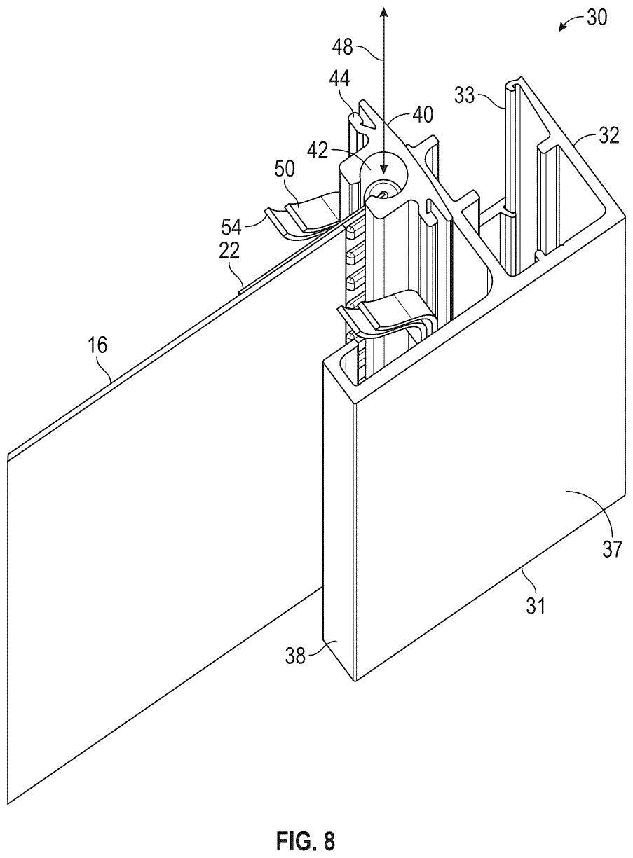

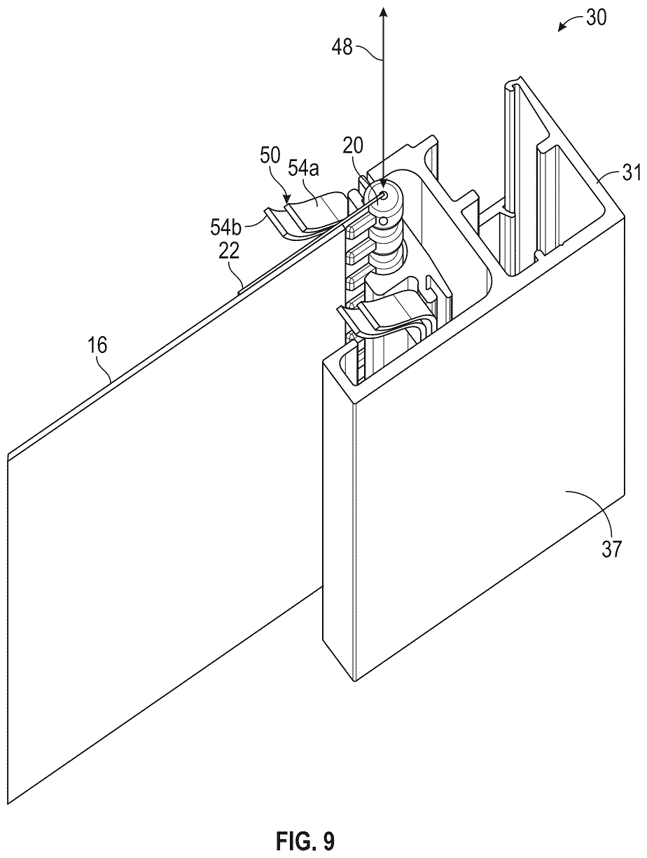

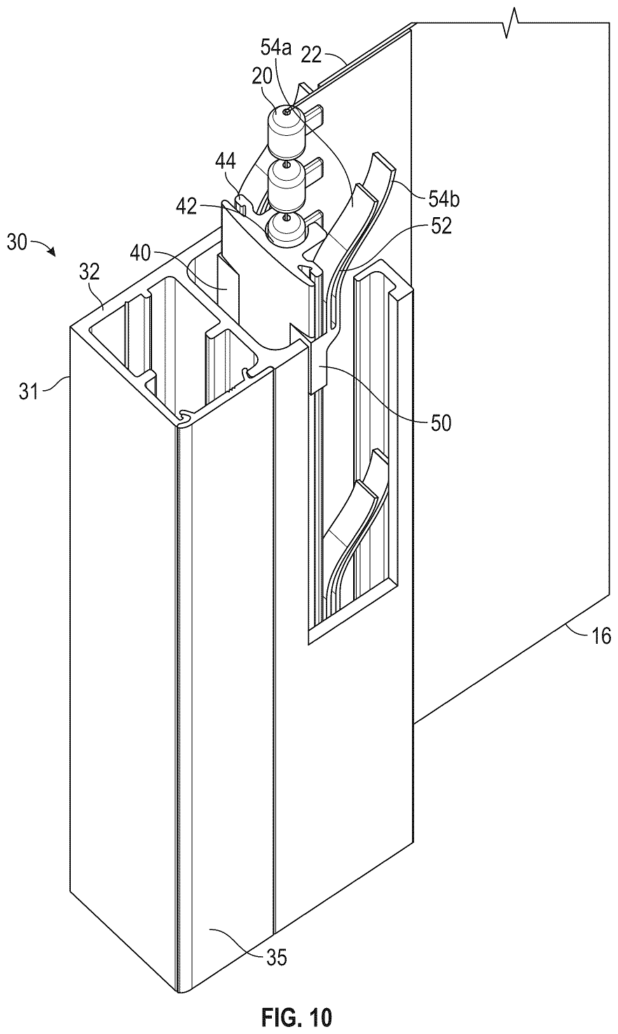

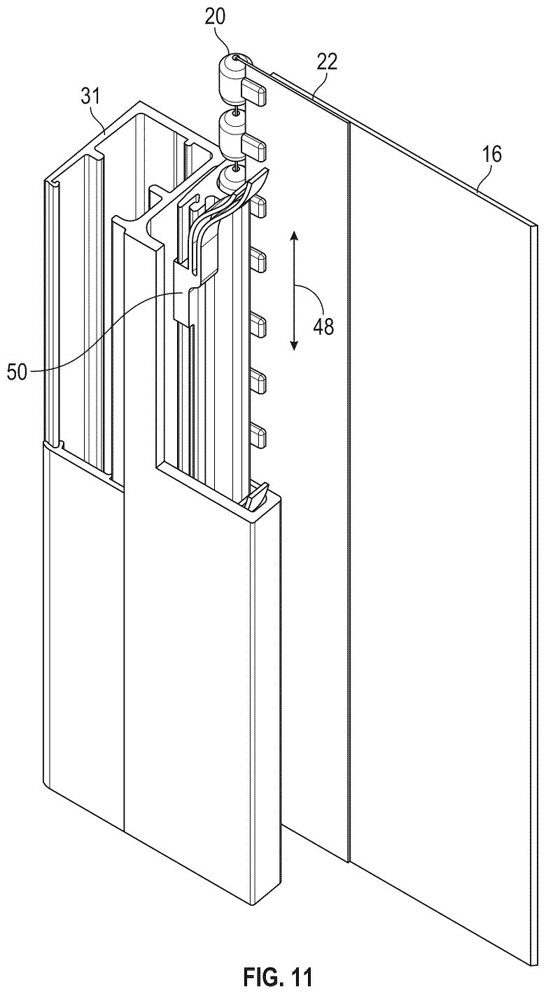

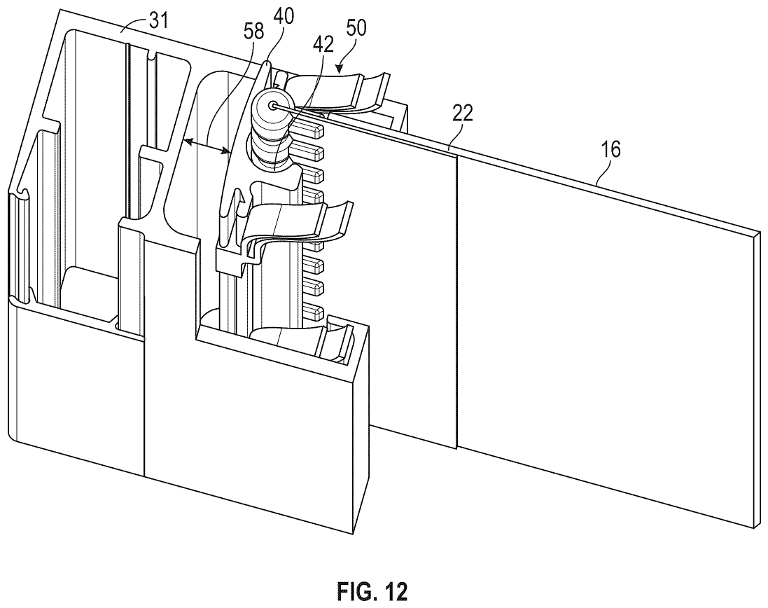

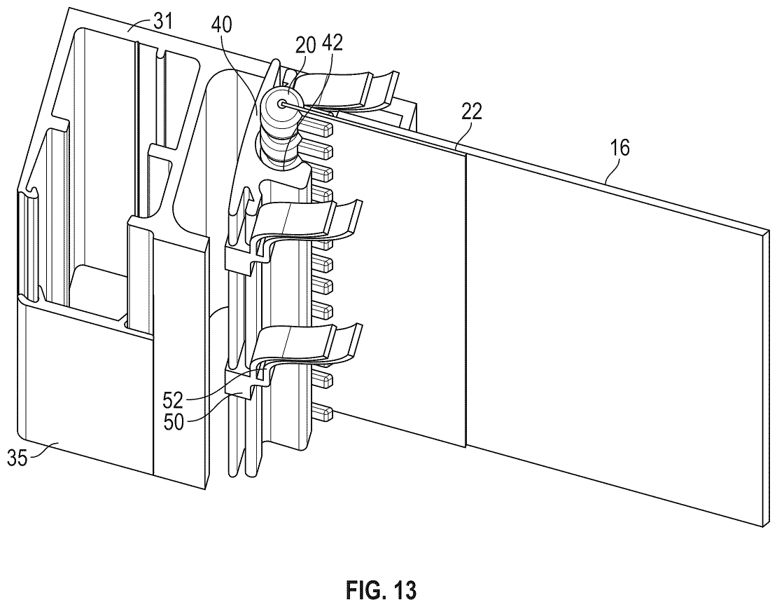

The track systems 30, and components thereof, are shown throughout FIGS. 3-21. As noted, FIG. 3 is a sectional, top-down view showing exterior and interior components of a track system according to aspects and/or embodiments of the present disclosure. The track system 30 includes an outer rail 31. The outer rail 31 is a structural component and can be used to mount or connect the track system to a portion of a structure. For example, a mounting member, such as screws, bolts, angle irons, tubes, or the like could be used to connect and mount the outer rail 31 to a portion of the structure to mount the screen system. For example, a mechanical fastener can be positioned through a portion of an outer connection portion 32 of the outer rail 31.

In general, a mechanical fastener is a device that is used to mechanically join or fasten two or more objects together. In general, fasteners are used to create non-permanent joints or connections; that is, joints that can be removed or dismantled without damaging the joining components. General types of mechanical fasteners can include threaded (bolts, screws, nuts, studs, etc.) or non-threaded (keys, pins, retaining rings, etc.). Additional fasteners can include, but are not limited to nails, rivets, and the like. Non-mechanical fasteners may include adhesives, fittings, clearance fittings, friction fittings, compression fittings, transition fittings, snaps, snap fits, hook and loops, joints, and the like. For simplistic purposes, screws, nuts, bolts, pins, rivets, staples, washers, grommets, latches (including pawls), ratchets, clamps, clasps, flanges, ties, adhesives, welds, any other known fastening mechanisms, or any combination thereof may be used to facilitate fastening, may be used for any of the connections described herein and all are to be considered swappable with one another for any of the attachment, connection, and/or fastening of components, either temporarily or permanently. It is further considered that any combination of any of the listed mechanical and/or non-mechanical fasteners or methods of fastening are to be considered a part of the disclosure.

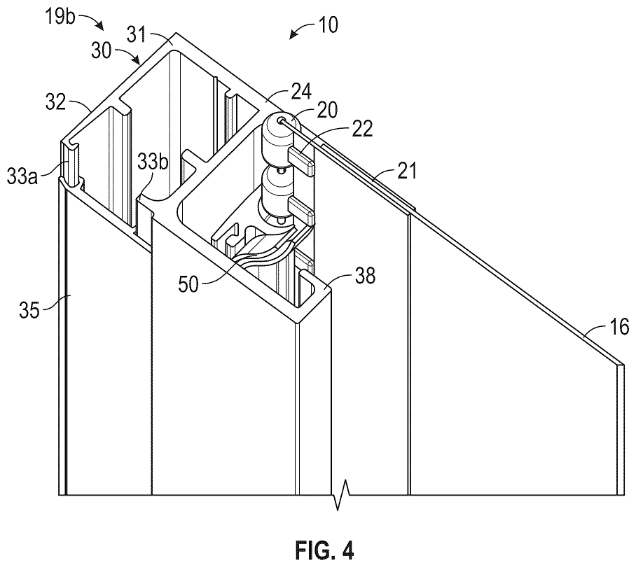

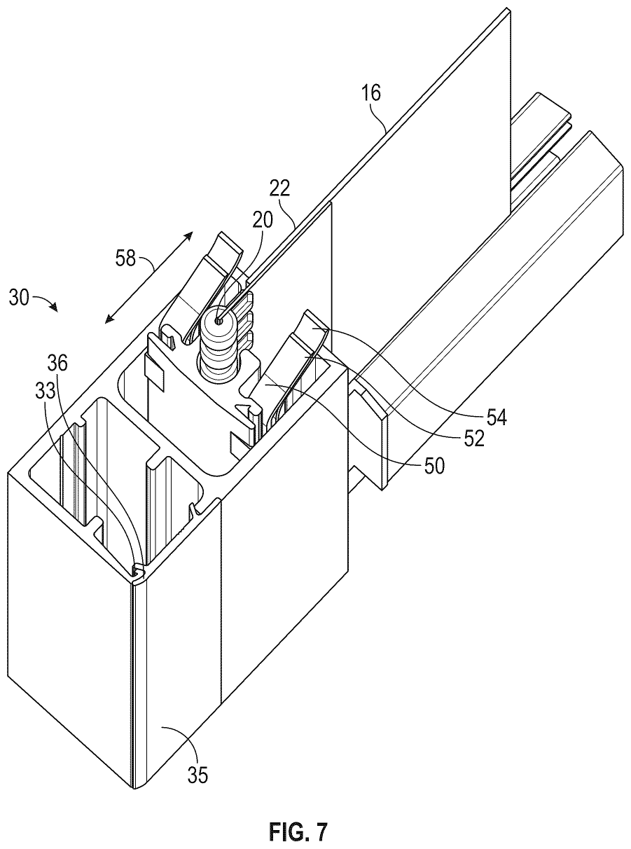

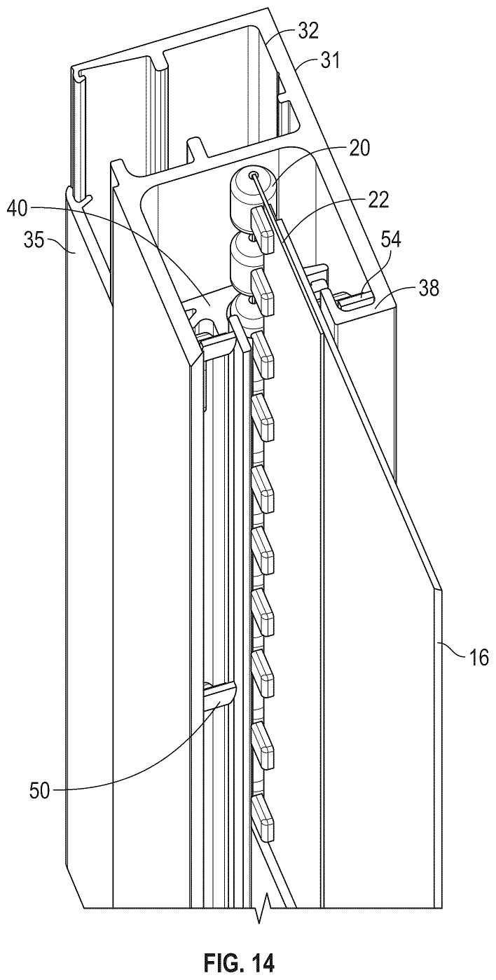

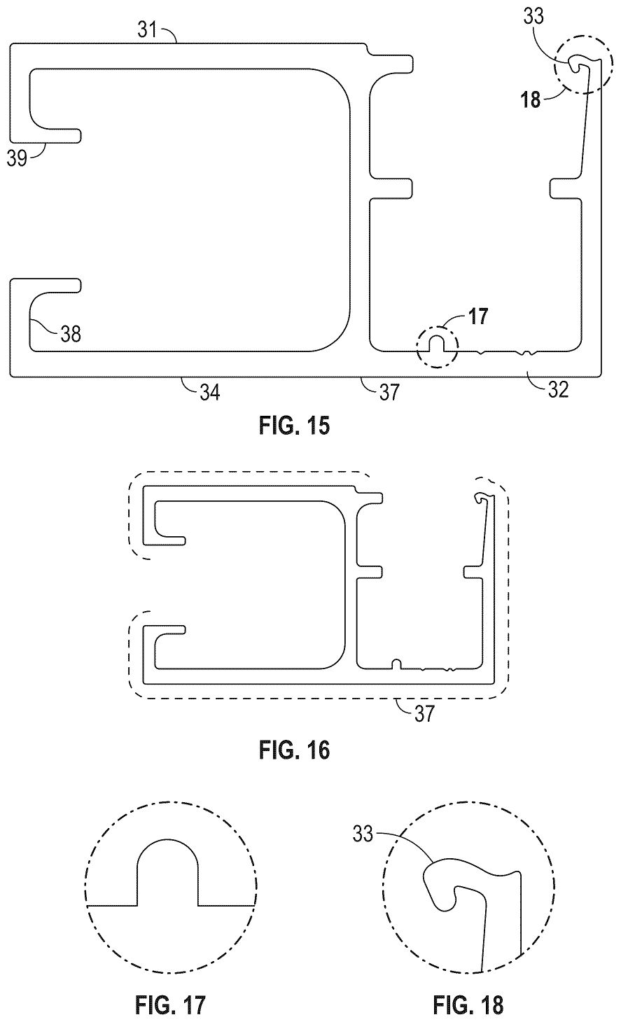

In addition, it is noted that the outer connection portion 32 includes an open side or portion. According to some embodiments, this open side makes the outer connection portion a c-shaped member. However, the opening can be any size, changing the general shape thereof. The opening allows the outer rail 31 to be connected to the structure, or some intervening member that is used to connect to a structure. This opening can be closed via a cover 35. According to at least some aspects of some embodiments, the cover 35 is snap fit to the outer rail 31, such as via connection arms 33 (see, e.g., connection arms 33a and 33b in FIG. 4 and also FIGS. 15-18) and snap fit channels 36 (see, e.g., FIG. 7) of the cover 35. In such a configuration, the cover 35 would be the face view 37 of the system, but this could be oriented such that any face of the outer rail 31 is the face view.

Also part of the outer rail 31 is an inner track portion 34, which extends from the outer connection portion 32. In some configurations, the outer connection portion 32 and the inner track portion 34 are a one-piece unit that is extruded and comprises a plastic or other rigid or semi-rigid member.

As shown, the inner track 34 is a generally c-shaped or concave member, with the opening 39 facing inward towards the screen 16. As will be understood, the inner track 34 houses some components of the floating rail system 30 and allows for the movement of components to attach the screen, allow the screen to move, and to allow for portions to float generally transverse in direction to the movement of the guide members 20 (i.e., generally horizontal).

Generally positioned or otherwise mounted in the inner track 34 is a screen connector or retention insert 40. The retention insert 40 generally spans the inner track 34 and includes an inner channel 42 and connector arms 44. The inner channel 42 is sized and/or shaped to receive the guide members 20 to aid in moving the guide members, and thus, the attached screen 16 through the track system 30 to raise and lower the screen 16, such as by extending and retracting the same.

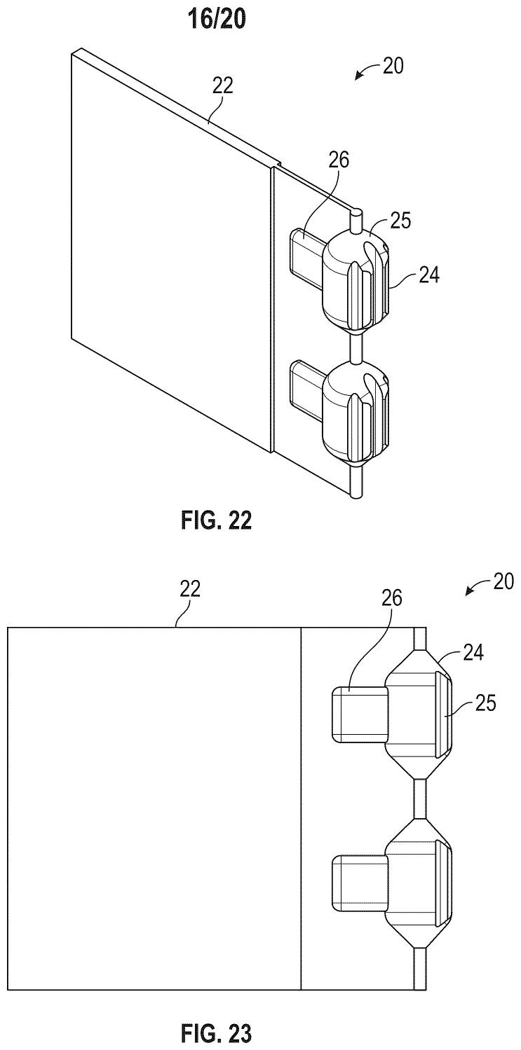

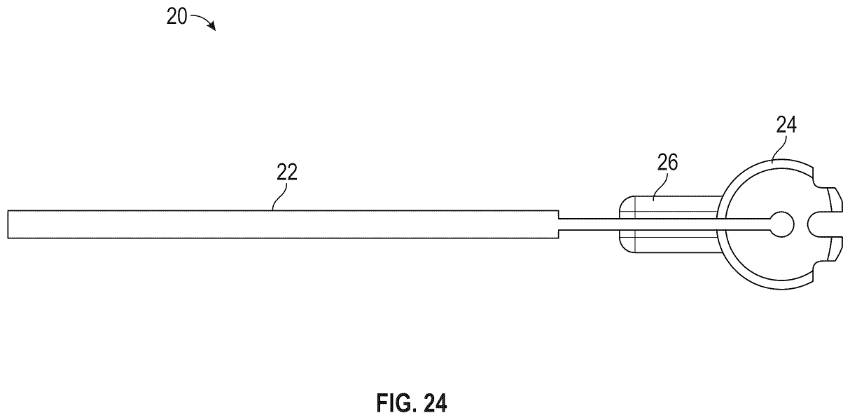

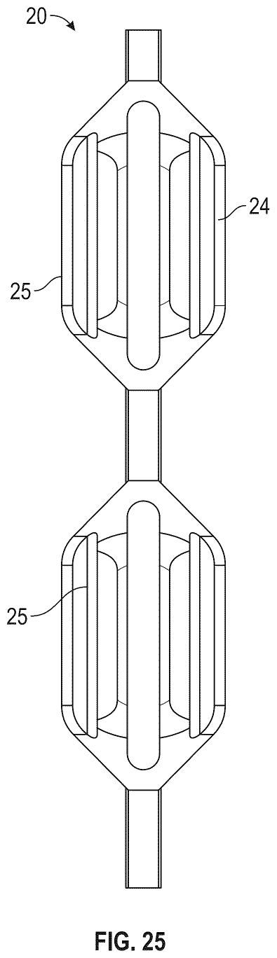

For example, the guide members 20 are shown in FIGS. 22-25, where they comprise a keder body 24 in the form of a bullet keder 25 that is attached to a weld 22 or overlap portion 21 via arms 26. The weld 22 may be referred to as keder tape that is used to attach the guide members 20 to the screen 16. The overlap 21 may be a portion where the screen 16 is connected to the keder tap via the weld 22 to hold the components together. It should be noted that while the particular size, shape, and/or configuration of keder body (i.e., the keder bullet) is shown and described, this is not the only configuration considered to be a part of the disclosure, and that any configuration capable of moving through the inner channel 42 is considered to be a part of the present disclosure.

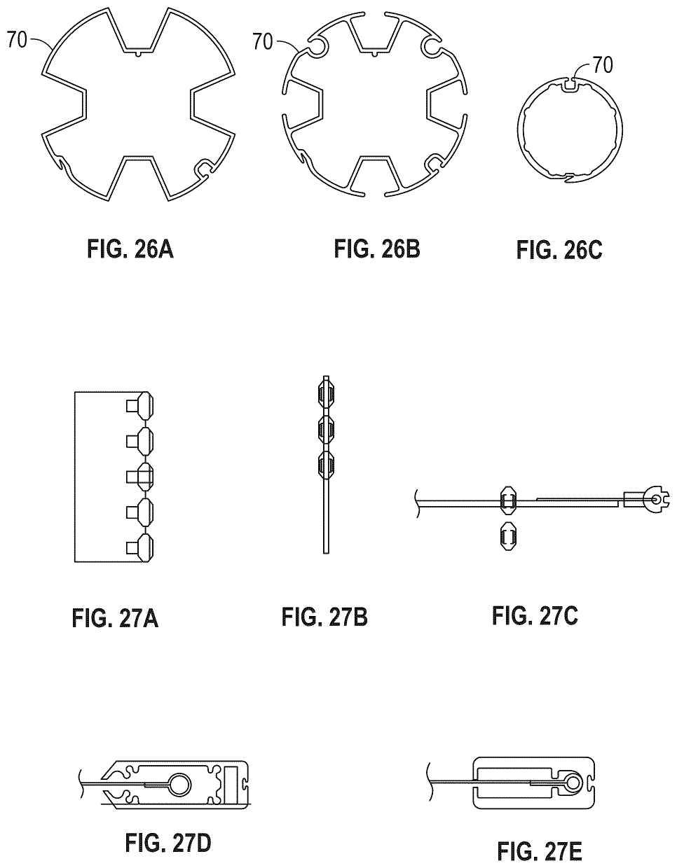

Moving back to FIGS. 3-15, the movement of the guide members 20 through the inner channel is shown. As previously noted, one end of the guide members 20 and screen 16 combination is connected to a roller 70 (see, e.g., the various configurations of rollers 70 shown in FIGS. 26A-26C) in the housing 12 of FIG. 2. The rotation of the roller will cause the attached screen via the guide members to extend or retract. The movement, which is shown by the arrow 48 in the figures, is aided and guided by the inner channel 42 of the retention insert. The inner channel 42 may extend the full height of the screen and system to provide for best guiding or may have a shorter length or otherwise be intermittent.

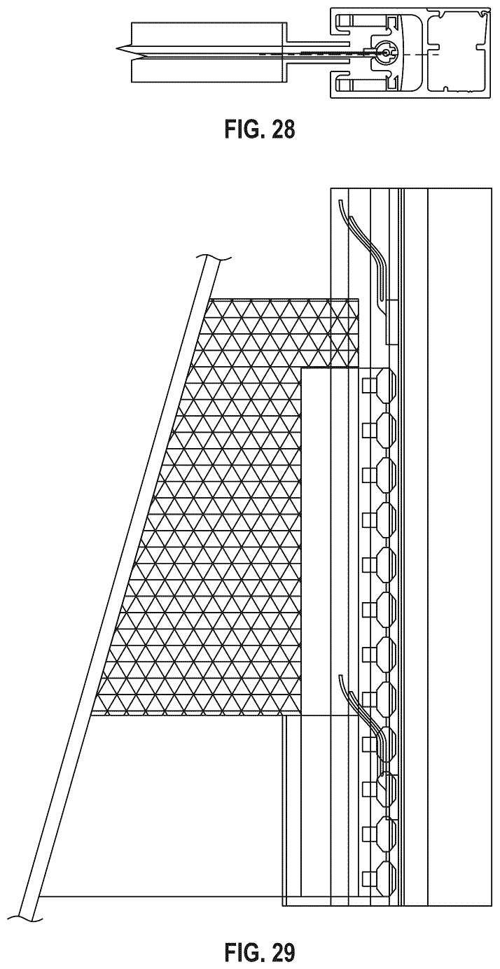

As can be seen in the figures, there are a plurality of guide members 20 (see, e.g., FIGS. 27A-27E, FIG. 28, and FIG. 29 showing the number of guide members in the channel 42) along the height 17 of the screen 16, which will provide aided movement and support in the channel 42, which will improve the utility of the system 10, especially when used for storm protection. The figures show various stages of movement of the screen 16, and thus, various placement of the guide members 20 relative to the track system 30.

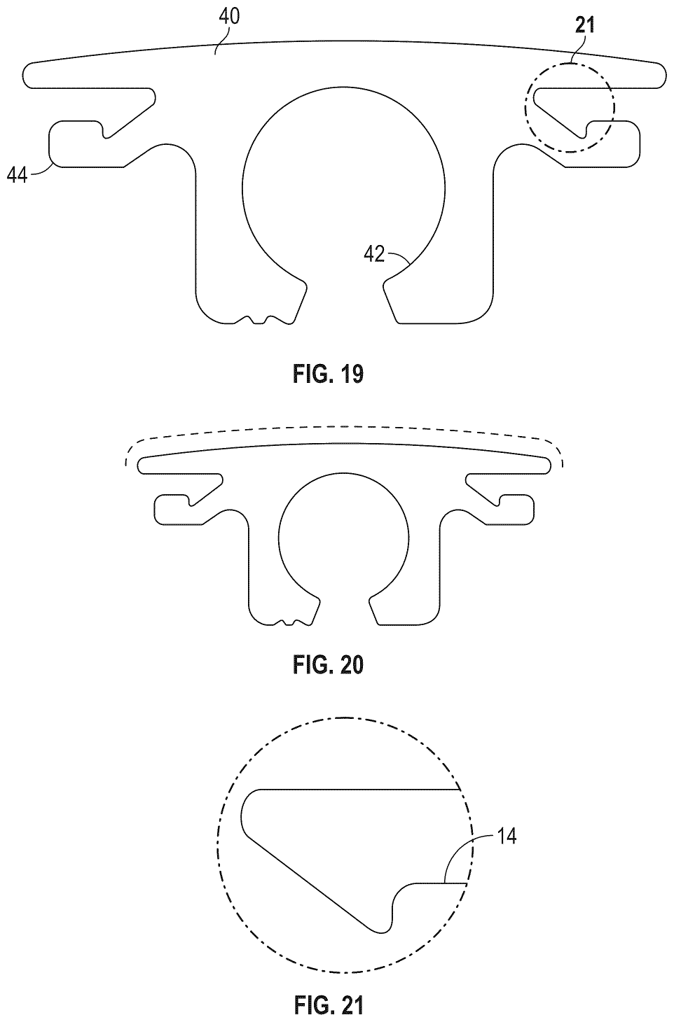

Additional aspects of the retention insert 40 are shown in FIGS. 19-21. As noted, the channel 42 includes an opening at one end to allow a portion of the guide member 20 and/or screen 16 to extend. There are also connector arms 44 forming a channel at opposing sides of the insert 40. These connector arms 44 and channels 44 are used to connect spring clips 50 to the retention insert.

The track system 30 has been referred to as a floating system herein. The retention insert 40 and spring clips 50 attached thereto allow for the retention insert 40 to move relative to the generally static outer rail 31, such as generally transversely to the height of the retention insert 40. This is shown by the arrow 58 in the figures. The floating will provide some correction for an amount of error in the installation of the system or due to the structure that the system is attached (i.e., will allow continued movement of the screen when the opposing track systems 30 on either side are not parallel to one another). The floating will add to the tolerance for non-parallel mounting tracks.

The spring clips 50 are disclosed and covered by U.S. Pat. No. 9,556,669, the description of which being hereby incorporated in its entirety. The clips 50 can be purchased from Plastex SA of Madonna del Piano, Switzerland. For example, Plastex Product No. 12189400 ClipMaxi (which is covered by the '669 patent) is one example for a spring clip, but it should be noted that other products and/or tension springs can be used.

For example, generally any member that can provide a tension that urges the retention insert towards the outer rail 31, but which allows for movement in the opposing direction, can be used with the track system 30 to allow for the floating of the retention insert and to provide the advantages of the present disclosure.

As shown herein and described in the '669 patent, the spring clip 50 includes one or more spring arms/tongues 54. The arms are angled to form tension springs 52 when a force is applied on the extended arms 54. At a base of the clips 50 are connector channels 56 (see, e.g., FIG. 3) that coincide with the connector arms 44 of the retention insert to mount to spring clips 50 to the retention insert 40. It should be noted that a number of spring clips can be mounted along the height of the retention insert 40, and it should be noted that the present disclosure encompasses the use of one or up to N, with N being any integer greater than 1 for use with the system. For example, the number of spring clips 50 may be dependent on the height of the retention insert and opening covered by the screen. According to at least some aspects, the spring clips 50 are positioned at substantially equal distances from one another to provide the tensioning and ability for the retention insert to float or move.

As disclosed throughout the figures, the spring clips 50 are positioned such that the arms 54 are positioned within spring retention channels 38 of the outer rail 31. The retention channels 38 are located generally at the distal ends of the inner track 34 at the otherwise open end 39. The channels 38 are formed by walls of the track and are generally c-shaped or otherwise concave with their opening towards in the inside portion of the inner track 34 of the outer rail 31. Thus, the arms 54 of the spring clips 50 are positioned within the c-shaped channels 38, with the walls thereof configured to house and maintain the positioning of the arms.

In addition, the depth and location of the channels relative to the outer rail 35 is determined based, in part, on the length of the spring clip arms 54 and the desired tensioning therefrom. According to at least some aspects of some embodiments, the spring clip arms 54 will urge the retention insert 40 away from the channels and towards the outer connection portion 32 of the outer rail 31. However, the tensioned arms will provide some give to allow the retention insert to move relative to the outer rail 31, such substantially via the direction of the arrow 58 (see, e.g., FIG. 7).

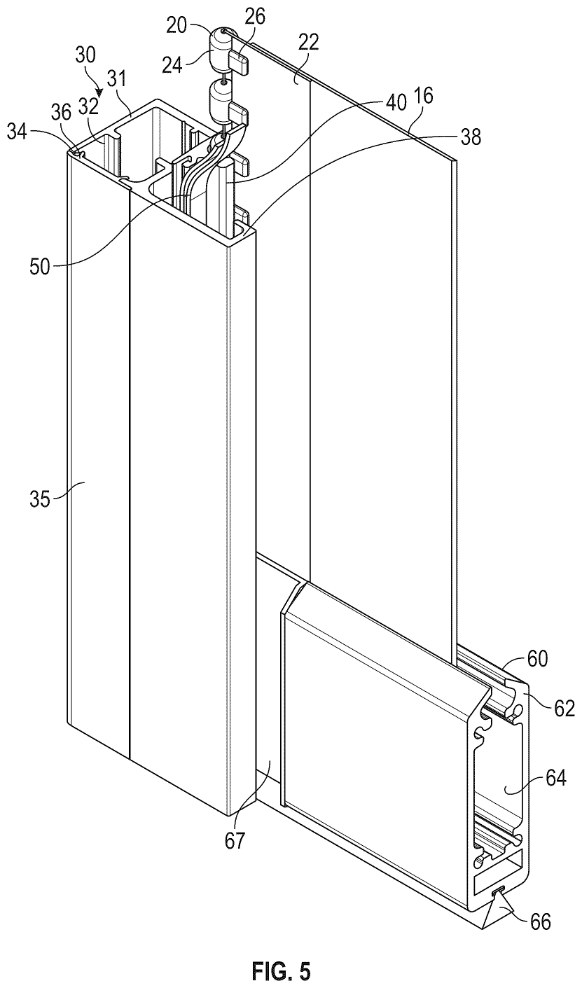

Additional features of the retractable screen 10 are shown in FIG. 5, which includes a lower portion of the system 10. As noted, the track system 30, including the outer rail 31 and the retention insert 40, will extend generally the height of the opening for mounting the screen system 10. At or near the bottom of the screen 16 is a bottom member 60 attached along the width 18 of the screen 16. According to at least some aspects of some embodiments, the bottom member 60 is a hem-bar that includes a housing 62 with tracks 64. The tracks 64 can be used to attached to a bottom portion of the screen 16 (not shown). The tracks 64 allow for some movement of the bottom of the screen 16 relative to the housing 62, which can account for non-level environments. For example, when fully extended, it is desirable that the bottom portion of the screen 16 contact or nearly contact a ground surface to enclose the opening. However, this ground surface may not always be level, and therefore, to account for such, the hem-bar allows for some movement of the screen relative to the housing to allow for the screen to extend, or at least appear to extend, fully to the ground. In other words, this allows for self-leveling of the bottom of the screen system when the floor or other ground surface slopes.

However, it should be noted that this hem-bar is not required in all embodiments and therefore may be considered an optional component of some embodiments or as part of some aspects of some embodiments.

Additionally shown in FIG. 5 is a glider 67 and brush 66. The glider allows for movement of the screen, while the brush provides a member that will also aid in enclosing the bottom portion of the screen 16 at or near the ground surface. The bottom brush 66 can mitigate insects from being able to pass through the bottom of the screen.

Therefore, a retractable screen system 10 for use with a number of different screen types has been shown and/or described. The screen system 10 includes improved guide members in the form of bullet keders 20 and also an improved mounting system 30 that allows for use even if there is some error in the mounting of the system or in the structure being mounted thereto. The mounting system includes a floating rail system that allows for at least some movement in a direction that is or includes a transverse directional component relative to the vertical movement (or a movement have a vertical component) for the movement of the screen relative to the rail system. The use of tension springs or other components that provide tension in the rail system allows for some movement inward or outward constituting the “floating” of the system.

While certain aspects and/or embodiments have been shown and/or described, it should be appreciated that any of the aspects of any of the embodiments could be combined in ways that may not be explicitly shown, but which are considered a part of the present disclosure, such as by way of inherency.

1. A retractable screen system, comprising:
a screen comprising a height and a width, said width defined by opposite lateral ends;
a plurality of guide members spaced vertically along the opposite lateral ends of the screen;
a track system at both of the lateral ends of the screen, each track system comprising:
an outer rail;
a screen connector including an inner channel movably positioned within a portion of outer rail; and
one or more tension springs positioned adjacent the screen connector in the outer rail;
wherein the plurality of guide members movable through the inner channel; and
wherein the screen connector movable in a direction transverse to the movement of the guide members.

2. The retractable screen system of claim 1, wherein the one or more tension springs urge the screen connector away from a center of the screen.

3. The retractable screen system of claim 1, wherein the outer rail comprises an outer connection portion for connecting to a mounting member, and an inner track, wherein the screen connector and one or more tension springs positioned in the inner track.

4. The retractable screen system of claim 1, wherein the one or more tension springs are connected to the screen connector.

5. The retractable screen system of claim 1, wherein the screen comprises fabric.

6. The retractable screen system of claim 1, wherein the plurality of guide members are connected to the screen via welding.

7. The retractable screen system of claim 1, further comprising a wall mount.

8. The retractable screen system of claim 7, wherein the track system connects to the wall mount.

9. The retractable screen system of claim 1, wherein the plurality of guide members comprise keders.

10. The retractable screen system of claim 1, further comprising a rolling motor operatively connected to the screen to raise and lower the screen.

11. A track system for use with a retractable screen having a guide member attached to opposite lateral ends of the screen, comprising:
an outer rail;
a screen connector including an inner channel movably positioned within a portion of outer rail; and
one or more tension springs positioned adjacent the screen connector in the outer rail;
wherein the plurality of guide members movable through the inner channel.

12. The track system of claim 11, wherein the outer rail comprises an outer connection portion for connecting to a mounting member, and an inner track, wherein the screen connector and one or more tension springs positioned in the inner track.

13. The track system of claim 11, wherein the one or more tension springs are connected to the screen connector.

14. The track system of claim 11, further comprising a wall mount.

15. The track system of claim 14, wherein the outer rail connects to the wall mount.

16. The track system of claim 11, wherein the plurality of guide members comprise keders.

17. A floating rail system for use with retractable screens, comprising:
an outer rail comprising a first portion for attaching to a wall mount and a second section comprising a channel;
a floating screen connector positioned in the channel of the outer rail, the floating screen connector comprising an inner channel and a tension spring;
wherein the tension spring urges the inner channel in the channel of the outer rail and allows the inner channel to move in the channel.

18. The floating rail system of claim 17, wherein the channel of the outer rail comprises a C-shape with an open end.

19. The floating rail system of claim 17, wherein the inner channel comprises a guide channel for receiving a guide member of a screen.

20. The floating rail system of claim 19, wherein the guide channel is substantially circular in shape.
